(19) United States
(12) Patent Application Publication
(10) Pub. No.: US 2023/0364803 A1
(43) Pub. Date: Nov. 16, 2023

(54) CONTROL APPARATUS, CONTROL SYSTEM, CONTROL METHOD, AND ROBOT

(71) Applicant: SONY GROUP CORPORATION, Tokyo (JP)

(72) Inventors: Tetsuya NARITA, Tokyo (JP); Tomoko KATSUHARA, Tokyo (JP); William Alexandre CONUS, Tokyo (JP); Nobukazu HIRAI, Tokyo (JP); Tetsuro GOTO, Tokyo (JP)

(73) Assignee: SONY GROUP CORPORATION, Tokyo (JP)

(21) Appl. No.: 18/044,724

(22) PCT Filed: Sep. 6, 2021
(86) PCT No.: PCT/JP2021/032626

§ 371 Date: Mar. 9, 2023

(30) Foreign Application Priority Data
Sep. 16, 2020 (JP) 2020-155048

(51) Int. Cl. B25J 13/08; B25J 9/16

(52) U.S. Cl. CPC B25J 13/089; B25J 9/1697; B25J 13/084

(57) ABSTRACT

To provide a control apparatus, a control system, a control method, and a robot by which a movement of the robot can be made a movement suitable for a surrounding environment. A control apparatus includes a control unit. The control unit controls an operation of a robot on the basis of a map of an operation region that reflects weighting of placement stability information of an object that forms the operation region of the robot, the map being generated using surrounding environment information of the robot.

### TECHNICAL FIELD

The present technology relates to a control apparatus, a control system, a control method, and a robot that controls a movement of a robot.

### BACKGROUND ART

Patent Literature 1 has described a robot that stacks and transports a plurality of objects. According to Patent Literature 1, a placement area for objects is calculated in advance so as to stably stack the objects, and order and place for stacking them are planned in accordance with the area.

### CITATION LIST

### Patent Literature

Patent Literature 1: Japanese Patent Application Laid-open No. 2016-196052

### DISCLOSURE OF INVENTION

### Technical Problem

The robot is desired to make a movement suitable for a surrounding environment.

The present disclosure has been made to provide a control apparatus, a control system, a control method, and a robot by which a movement of the robot can be made a movement suitable for a surrounding environment.

### Solution to Problem

A control apparatus according to an embodiment of the present technology includes a control unit.

The control unit controls an operation of a robot on the basis of a map of an operation region that reflects weighting of placement stability information of an object that forms the operation region of the robot, the map being generated using surrounding environment information of the robot.

The placement stability information of the object may be calculated using one or more selected from a shape of the object, a contact area of the object with another object, a material of the object, a friction coefficient of the object, a contact state of the object with another object, rigidity of the object, result information when the robot operates on the basis of the map, and a deformation rate of the object during contact with the robot.

The environment information may be information based on a sensing result of a vision sensor that acquires surrounding information of the robot and the environment information includes shape information of the object, position information of the object in the operation region, and relative position relationship information between the robot and the object.

The map may be generated using the placement stability information of the object calculated in advance.

The map may be generated using the placement stability information of the object calculated using at least one of a sensing result of the first sensor provided in the robot and a sensing result of a vision sensor that acquires surrounding information of the robot.

The placement stability of the object may be calculated using at least one of a shape, a size, rigidity, a change in shape over time, and a contact area with another object of the object determined on the basis of at least one of the sensing result of the first sensor and the sensing result of the vision sensor.

The first sensor may include at least one of a force sensor and a tactile sensor.

The robot may be provided with a manipulator having a joint, a link that rotates about the joint as a center, and a holding unit that holds or releases a target object, the manipulator being provided at a distal end,
the control unit may control the operation of the robot on the basis of at least one of a trajectory of the holding unit and a trajectory of the joint, the trajectories being generated using the map.

When the manipulator may move retaining the target object by use of the holding unit and may place the target object at a target reaching point in the operation region, the control unit determines the target reaching point on the basis of the map.

The control unit may determine the target reaching point in view of the placement stability information of the target object.

The control unit may calculate a control parameter of the robot on the basis of the placement stability information of the object.

The control unit may control position and attitude of the robot on the basis of the placement stability information of the object.

The control unit may calculate the placement stability of the object by use of a sensing result of a vision sensor that acquires surrounding information of the robot and a learning model.

The control unit may generate the map by use of the placement stability information of the object, the placement stability information being obtained by another robot different from the robot.

A control system according to an embodiment of the present technology includes:
a robot; and
a control unit controls an operation of the robot on the basis of a map of an operation region that reflects weighting of placement stability information of an object that forms the operation region of the robot, the map being generated by use of surrounding environment information of the robot.

A control method according to an embodiment of the present technology includes: generating a map of an operation region that reflects weighting of placement stability information of an object that forms an operation region of the robot by use of surrounding environment information of the robot; and controlling an operation of the robot on the basis of the map.

A robot according to an embodiment of the present technology includes a control unit that controls an operation of the robot on the basis of a map of an operation region that reflects weighting of placement stability information of an object that forms an operation region of the robot, the map being generated using surrounding environment information of the robot.

### BRIEF DESCRIPTION OF DRAWINGS

FIG. 1 A diagram showing how a robot provided with a manipulator takes an object out of a refrigerator.

FIG. 2 A schematic diagram showing a configuration of a control system of the robot according to an embodiment.

FIG. 3 A block diagram showing functional configuration examples of a control unit that controls a movement of the robot according to the embodiment.

FIG. 4 A diagram for describing weights of an operation region defined on the basis of placement stability information of objects.

FIG. 5 A diagram describing an example of a generation method for a trajectory based on a weighting map.

FIG. 6 A diagram describing another example of the generation method for the trajectory based on the weighting map.

FIG. 7 A diagram describing a generated trajectory example.

FIG. 8 A flow diagram of a control method according to the embodiment.

FIG. 9 A block diagram showing functional configuration examples of a control unit that controls a movement of a robot according to Modified Example 1.

FIG. 10 A flow diagram of a control method according to Modified Example 1.

FIG. 11 A block diagram showing functional configuration examples of a control unit that controls a movement of a robot according to Modified Example 2.

FIG. 12 A diagram showing how a target object gripped by an end effector is placed in a refrigerator.

FIG. 13 A block diagram showing functional configuration examples of a control unit that controls a movement of a robot according to Modified Example 3.

FIG. 14 A diagram showing an example in which the robot moves to a position suitable for taking out when the robot takes out a target object.

FIG. 15 A block diagram showing functional configuration examples of a control unit that controls a movement of a robot according to Modified Example 4.

FIG. 16 A block diagram showing functional configuration examples of a control unit that controls a movement of a robot according to Modified Example 5.

### MODE(S) FOR CARRYING OUT THE INVENTION

Hereinafter, embodiments will be described with reference to the drawings. It should be noted that in the present specification and the drawings, components having substantially identical functional configurations will be denoted by the same reference signs and the overlap descriptions will be omitted.

### <Overview>

The present embodiment controls a robot so that the robot makes a movement suitable for a surrounding environment.

The “robot” is a movable object that has a manipulation function or movement function under automatic control and is at least partially movable. The robot performs various tasks. For example, the robot includes a movable object having a movement function with which the robot itself is configured to be movable. Moreover, the robot also include a robot having a manipulation function with which the robot itself is not configured to be movable. One of examples thereof is a manipulator having an articulated structure provided on a base fixedly placed. The manipulator operates by a driving source such a servo motor and a movable range changes by joints. Changing the type of end effector attached to a distal end of the manipulator can handle various tasks.

In the following description, a robot having a movement mechanism with a manipulator will be taken as an example of the robot. An example in which a work environment of the robot is a refrigerator and a target object is placed in/taken out of the refrigerator by the use of the manipulator will be described. It should be noted that although the interior of the refrigerator is taken as an example of an environment in which objects are placed, the environment may be a book shelf, for example, and the environment is not limited thereto.

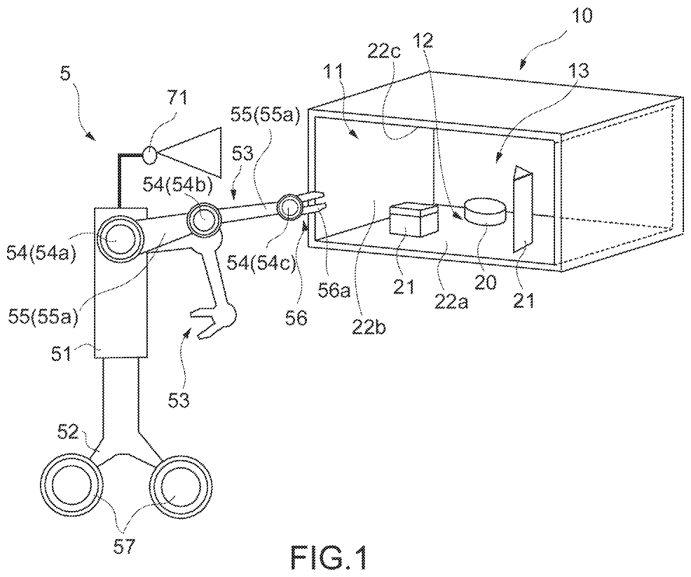

FIG. 1 shows how a robot 5 provided with a manipulator 53 takes an object out of a refrigerator 10. Hereinafter, in some cases, taking out a target object located inside the refrigerator will be referred to as carrying-out and placing a target object located outside the refrigerator in the refrigerator will be referred to as carrying-in.

The manipulator 53 is controlled so that at least one of a trajectory of an end effector 56 at its distal end and trajectories of target angles of joints 54 makes a movement suitable for a surrounding environment. Hereinafter, the trajectory of the end effector 56 and the trajectories of the target angles of the joints 54 will be simply referred to as a trajectory of the manipulator 53 in some cases. The surrounding environment includes an operation region 13 in which the manipulator 53 is operable. In the example shown in FIG. 1, the interior of the refrigerator 10 is a main operation region 13 of the manipulator when the manipulator performs a given target task.

In the present embodiment, a map of the operation region that reflects weighting of placement stability information of an object that forms the operation region is used for generation of a trajectory of the manipulator in the operation region (manipulator operation planning). Hereinafter, such a map will be referred to as a “weighting map”.

Hereinafter, an object to be gripped by the end effector of the manipulator will be referred to as a target object and an object other than the target object will be referred to as a first object. It should be noted that in a case where it is not especially necessary to distinguish them as the first object and the target object, they will be simply referred to as “objects”.

FIG. 1 schematically shows a partial configuration of the refrigerator 10. The refrigerator 10 has a shelf that is storage 11 that stores objects 20 and 21 such as food products. The storage 11 is a region formed, surrounded by an in-refrigerator bottom surface 22a, in-refrigerator side surfaces 22b, and an in-refrigerator top surface 22c.

The operation region 13 inside the refrigerator 10 in which the manipulator 53 is operable is constituted by a plurality of objects.

The objects forming the operation region 13 include objects whose positions are fixed in advance and objects whose positions are variable.

The in-refrigerator bottom surface 22a, the in-refrigerator side surfaces 22b, and the in-refrigerator top surface 22c are objects whose positions are fixed in advance. The in-refrigerator bottom surface 22a, the in-refrigerator side surfaces 22b, and the in-refrigerator top surface 22c are objects other than target objects to be gripped by the end effector 56, and they are first objects.

In FIG. 1, the objects 20 and 21 placed in the storage 11 are objects whose positions are variable. The objects whose positions are variable include a target object to be gripped by the end effector 56 in a given target task and first objects that are other objects. The target object to be gripped by the end effector 56 will be denoted by the reference sign 20. It should be noted that a target object to be gripped by the end effector 56 in a target task, which is not placed in the refrigerator 10, will also be denoted by the reference sign 20. Out of the objects whose positions are variable and which are stored in the storage 11, a first object other than the target object will be denoted by the reference sign 21.

The operation region 13 is a surrounding environment of the manipulator 53 and a region in which the manipulator 53 is operable.

In the present embodiment, the movement of the manipulator is controlled on the basis of the weighting map so as to be a movement suitable for the operation region. Hereinafter, it will be described specifically.

It should be noted that in the present specification, the “placement stability” refers to a probability that an object can stay stably in the environment without moving. Otherwise, it is physically calculated stability against fall, collapse, and breakage conditions. A calculation method for the placement stability will be described later. For example, quasi-spherical objects like apples have lower placement stability because they roll easily. In this regard, cubic objects have higher placement stability.

In the present specification, the “environment” refers to a space in which the robot operates. In the example shown in FIG. 1, the operation region 13 defined by the in-refrigerator bottom surface 22a, the in-refrigerator side surfaces 22b, and the in-refrigerator top surface 22c of the refrigerator 10 and the objects 20 and 21 are an environment in which the manipulator 53 of the robot 5 operates.

In the present specification, the “self-position of the robot” refers to the robot's position in environment.

### <Schematic Configuration of Control System>

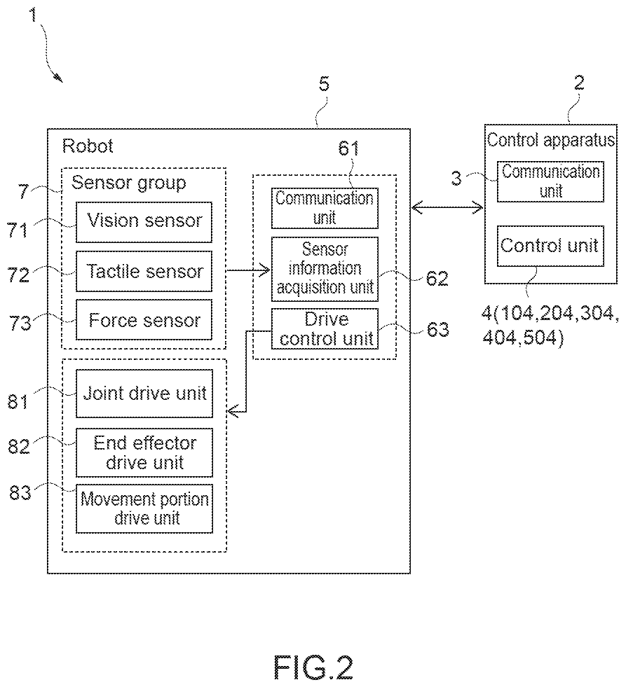

FIG. 2 is a schematic diagram of a control system 1 and is a diagram showing a configuration of the robot 5 and a control apparatus 2. As shown in FIG. 2, the control system 1 has the robot 5 and the control apparatus 2. In the present embodiment, the control apparatus 2 is an external apparatus different from the robot 5, and may be, for example, a server such as a cloud server.

### [Configuration of Robot]

A configuration example of the robot will be described with reference to FIGS. 1 and 2.

As shown in FIG. 1, the robot 5 has a body portion 51, leg portions 52 connected to the body portion 51, manipulators 53 extending from the body portion 51, and movement portions 57 provided at distal ends of the leg portions 52.

As shown in FIG. 2, the robot 5 has a sensor group 7, a joint drive unit 81, an end effector drive unit 82, and a movement portion drive unit 83. As shown in FIG. 2, the robot 5 also has a communication unit 61, a sensor information acquisition unit 62, and a drive control unit 63 shown in a functional configuration block.

As shown in FIG. 1, the manipulator 53 has a plurality of joints 54a to 54c, a plurality of links 55a and 55b coupled by the joints 54a to 54c, and the end effector 56 provided at the distal end. Considering the degree of freedom of position and attitude of the manipulator, the number and shape of joints and links and directions of drive shafts of the joints are set as appropriate so as to achieve a desired degree of freedom. It should be noted that in a case where it is not especially necessary to distinguish the respective joints as 54a to 54c, they will be referred to as joints 54. In a case where it is not especially necessary to distinguish the respective links as 55a and 55b, they will be referred to as links 55.

The links 55a and 55b are rod-like members. One end of the link 55a is coupled to the body portion 51 via the joint 54a. The other end of the link 55a is coupled to one end of the link 55b via the joint 54b. The other end of the link 55b is coupled to the end effector 56 via the joint 54c.

The joints 54a to 54c are coupled so as to be capable of rotating the links 55a and 55b. Each joint 54 has a rotating mechanism that includes the joint drive unit 81 such as an actuator and is rotationally driven with respect to a predetermined rotation shaft by driving of the joint drive unit 81. A movement of the manipulator 53, e.g., extending or contracting the entire shape of the manipulator 53 can be controlled by controlling driving of the rotation of each joint 54. Accordingly, the position and attitude of the manipulator 53 are controlled.

The end effector 56 is a holding unit configured to be capable of holding and releasing a target object. The type of the end effector 56 is not limited. For example, it may be a type of gripping a target object with a plurality of fingers, a scooper type of scooping a target object, or a type of adsorbing a target object. In the present embodiment, a gripper that is a gripping tool constituted by two fingers 56a will be taken as an example of the end effector 56. The end effector 56 includes an end effector drive unit 82 such as an actuator and movements of the fingers 56a are controlled by driving of the end effector drive unit 82. By changing the distance between the two fingers 56a, it is possible to grip a target object between the two fingers 56a and release the gripped object.

The position of each component (joint, link, end effector) of the manipulator 53 means a position (coordinates) in a space (operation region) defined for driving control. The attitude of each component means an orientation (angle) with respect to an arbitrary axis in the space (operation region) defined for driving control.

The driving of the manipulator 53 includes driving of the end effector 56, driving of the joints 54, and driving of the end effector 56 and the joints 54 so that the position and attitude of each component of the manipulator 53 are changed (the change is controlled). It can be said that the driving of the manipulator 53 is driving of the robot 5.

The joint drive unit 81 and the end effector drive unit 82 drive the manipulator 53 on the basis of a drive control signal output from the drive control unit 63 to be described later.

Moreover, the robot 5 is provided with the movement mechanism that is a movement means that moves the robot 5 itself in the space. The movement mechanism has the movement portions 57 that move the robot 5 and the movement portion drive unit 83 such as an actuator that drives the movement portions 57.

The movement mechanism includes a legged movement mechanism, a wheeled movement mechanism, a tracked movement mechanism, a propeller movement mechanism, and the like. The movable object provided with the legged movement mechanism, the wheel movement mechanism, or the infinite trajectory-type movement mechanism are movable on the ground. The robot provided with the propeller movement mechanism is movable by flying in the air.

In the present embodiment, the movement portions 57 are configured to be movable on the ground. The shape of the movement portions 57 is not limited. For example, in the example shown in FIG. 1, the robot 5 has the wheel-type movement portions 57.

As shown in FIG. 2, the movement portion drive unit 83 drives the movement portions 57. The movement portion drive unit 83 drives the movement portions 57 on the basis of a driving signal output from the drive control unit 63.

As shown in FIG. 2, the sensor group 7 includes a vision sensor 71, a tactile sensor 72, and a force sensor 73. Hereinafter, the tactile sensor 72 and the force sensor 73 will be referred to as first sensors in some cases, distinguished from the vision sensor 71.

In the example shown in FIG. 1, the vision sensor 71 is provided in the body portion 51 of the robot 5.

The vision sensor 71 acquires surrounding information of the robot. The vision sensor 71 acquires visual information. More specifically, the vision sensor 71 acquires RGB information and depth information. For example, a stereo camera or RGB-D camera capable of acquiring RGB information and depth information can be used. A monocular camera capable of acquiring RGB information can be used. A radar or the like using an echolocation method such as time of fright (TOF) or light detection and ranging, laser imaging detection and ranging (LiDAR) capable of acquiring depth information can be used. Hereinafter, RGB information and depth information that are sensing results of the vision sensor 71 will be referred to as “image information”.

Surrounding environment information of the manipulator can be obtained from the image information obtained from the vision sensor 71. The surrounding environment information includes shape information of the object located in the periphery of the manipulator 53, position information of an object in the operation region 13, and relative position relationship information between the manipulator 53 and each object, and the like. In the example shown in FIG. 1, the object located in the periphery of the manipulator 53 is the in-refrigerator bottom surface 22a, the in-refrigerator side surfaces 22b, the in-refrigerator top surface 22c, and the objects 20 and 21.

The placement position of the vision sensor 71 is not limited to the body portion 51 of the robot 5. It is sufficient that information about the periphery of the robot 5, more specifically, information about the region in which the end effector 56 is operable in order to perform the target task can be obtained. In the example shown in FIG. 1, the vision sensor 71 is placed to acquire information about the interior of the storage 11 of the refrigerator 10. The vision sensor 71 may be mounted on the manipulator 53 or may be placed inside the refrigerator 10. Moreover, vision sensors may be provided in both the robot 5 and the refrigerator 10. The number of vision sensors 71 only needs to be one or more.

The tactile sensor 72 and the force sensor 73 as the first sensors are attached to the manipulator 53.

The tactile sensor 72 is attached to each portion of the manipulator 53, which includes the end effector 56. The tactile sensor 72 is a sensor that detects a mechanical relationship between the object and the sensor and detects a distributed pressure, force and moment, a slide, and the like.

For example, the tactile sensor 72 detects contact strength when the manipulator 53 and the object are in contact with each other. By distributing a plurality of tactile sensors 72 at the respective portions of the manipulator 53, a contact strength distribution of the entire manipulator 53 can also be relatively represented.

A sensor with sensor elements each having a single detection point placed in an array form or a sensor in which a plurality of detection points are placed in an array form can be used as the tactile sensor 72.

A three-axis or six-axis force sensor can be used as the force sensor (torque sensor) 73. The force sensor 73 is attached to each of the end effector 56 and each joint 54.

The force sensor 73 is a sensor that measures a force between an object and the sensor and magnitude and direction of moment (torque).

Using sensing results of the first sensors (force sensor and tactile sensor), the placement stability of the object can be calculated. The details will be described later.

As shown in FIG. 2, the communication unit 61 communicates with an external apparatus such as the control apparatus 2 with a wire or wirelessly. The communication unit 61 sends to the control apparatus 2 sensing results of the respective sensors, the sensing results being acquired by the sensor information acquisition unit 6. The communication unit 61 receives from the control apparatus 2 a control parameter for controlling the operation of the manipulator 53, the control parameter being generated by a control unit 4 (104, 204, 304, 404, 504) to be described later.

The sensor information acquisition unit 62 acquires sensing results of the vision sensor 71, the tactile sensor 72, and the force sensor 73 mounted on the robot 1.

The drive control unit 63 drives the joint drive unit 81, the end effector drive unit 82, and the movement portion drive unit 83 on the basis of the control parameter received from the control apparatus 2.

### [Configuration of Control Apparatus]

As shown in FIG. 2, the control apparatus 2 has a communication unit 3 and the control unit 4 (104, 204, 304, 404, 504).

The communication unit 3 communicates with the robot 5 with a wire or wirelessly. The communication unit 3 receives from the robot 5 sensing results acquired by the respective sensors mounted on the robot 5. The communication unit 3 sends to the robot 5 a control signal generated by the control unit 4 (104, 204, 304, 404, 504).

The control unit 4 (104, 204, 304, 404, 504) controls the operation of the manipulator 53, mainly the operation of the robot 5 in the present embodiment, on the basis of the weighting map. The weighting map is a map of the operation region that reflects weighting of placement stability information of the object that forms an operation region of the manipulator 53 of the robot 5.

Hereinafter, the control unit 4 according to the present embodiment and the control units 104, 204, 304, 404, and 504 according to first to fifth modified examples will be described.

### Configuration of Control Unit 4

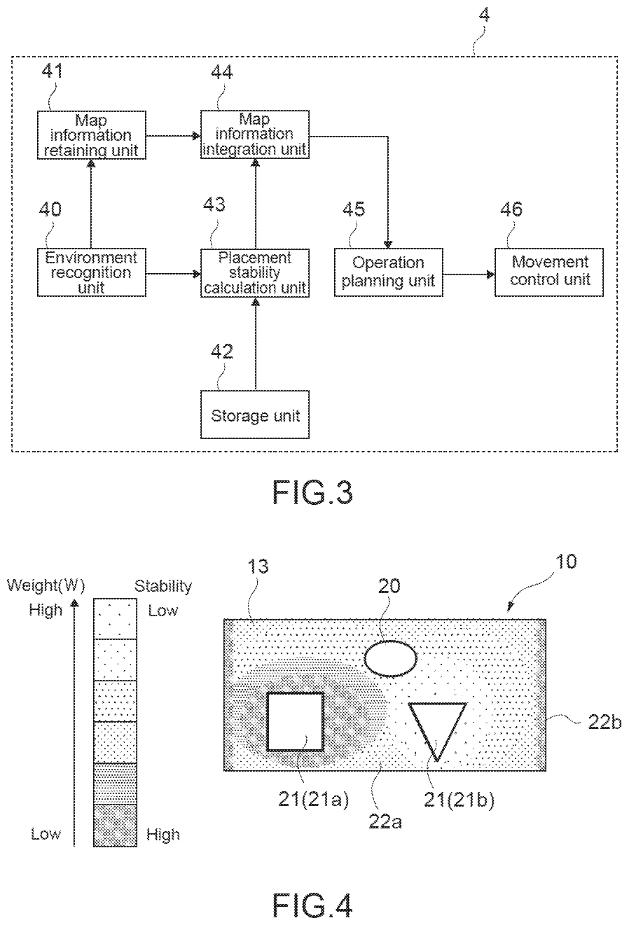

FIG. 3 is a functional configuration block diagram of the control unit 4 according to the present embodiment.

As shown in FIG. 3, the control unit 4 has an environment recognition unit 40, a map information retaining unit 41, a storage unit 42, a placement stability calculation unit 43, a map information integration unit 44, an operation planning unit 45, and a movement control unit 46.

Here, a movement when a target task (carrying-out task) of taking out a target object 20 located in the refrigerator 10 by the use of the manipulator 53 is given will be mainly described.

A flow of the carrying-out task is as follows. That is, the end effector 56 of the manipulator 53 moves from a position A outside the refrigerator 10 to a position B inside the refrigerator 10 at which the target object is located. Next, the end effector 56 grips the target object. Next, the end effector 56 moves from the position B (first position) to the position C (second position) outside the refrigerator 10 in a state of gripping the target object.

In this carrying-out task, a trajectory from the position A to the position B and a trajectory from the position B to the position C, through which the end effector 56 passes, are generated on the basis of the weighting map. In addition, trajectories of the target angles of the respective joints are generated in addition to the trajectories of the end effector.

The environment recognition unit 40 acquires image information that is a sensing result of the vision sensor 71 acquired via the communication unit 3. The environment recognition unit 40 performs recognition processing on an object in an image with the image information. Moreover, the environment recognition unit 40 may perform processing of extracting information about shape, material, and the like of the recognized object with the image information.

As a result of the processing, shape and material information of the manipulator located in the periphery of the object, position information of the object in the operation region 13, distance information between the manipulator 53 and the object, information about contact state, contact area, and the like of two different objects in contact, which form the operation region, and the like can be obtained. The shape of the object includes an outline of the object, a size of the object, an aspect ratio, an angle of inclination, and the like.

Moreover, in a case where the recognized object has characters, character recognition processing may be performed and name information of the object can be acquired.

The image information and the above-mentioned information obtained by the processing at the environment recognition unit 40 are surrounding environment information of the manipulator 53. It can also be said that the surrounding environment information is information about the operation region in which the manipulator operates, which is formed by the objects. The surrounding environment information is output to the map information retaining unit 41 and the placement stability calculation unit 43.

The map information retaining unit 41 generates an initial map of the operation region 13 on the basis of surrounding environment information obtained by the environment recognition unit 40. The initial map is a map before it is weighted. Here, it will be referred to as an “initial map”, distinguished from the above-mentioned “weighting map”. The initial map includes at least one of a position of an object located in the periphery of the robot, a relative position relationship between the different objects, a self-position of the robot, the shape and size of the object positioned in the periphery of the robot, and segmentation information of the object. The initial map may be two-dimensional or may be three-dimensional.

The storage unit 42 stores database associated with the placement stability information of the object defined in advance. The placement stability may be a continuous value or may be a discrete value. The storage unit 42 stores, for example, object names and abstract features and the like of the objects in association with numeric values of the placement stability. The abstract features of the objects are primitive shapes of the objects, for example, spherical, cylindrical, and rectangular parallelepiped shapes. Such information is stored in the form of a table, for example, and the placement stability calculation unit 43 to be described later can retrieve numeric values of the placement stability by keywords or the like. Here, the example in which they are stored in the table form is taken, though not limited thereto.

As the numeric values of the placement stability, values may be registered in advance or may be capable of being updated manually by humans. Moreover, they may be updated at any time on the basis of result information (hereinafter, referred to as past manipulation result information) obtained when the robot 5 moves on the basis of a generated trajectory. An example of a calculation method for the placement stability will be described later.

Using object information subjected to object recognition by the environment recognition unit 40 and the table stored in the storage unit 42, the placement stability calculation unit 43 calculates a numeric value of the placement stability of the object subjected to object recognition. Accordingly, a numeric value of the placement stability for each of the objects forming the operation region 13 is calculated. The calculated numeric value of the placement stability is output to the map information integration unit 44.

It should be noted that in a case where the object registered in the table does not match the object recognized by the environment recognition unit 40, placement stability of the initial value defined in advance may be used. Otherwise, an object similar to the object shape recognized on the basis of the image information may be extracted from the table and a numeric value of the placement stability associated with the extracted object may be used. Otherwise, a numeric value of the placement stability calculated from the primitive shape of the object on the basis of the image information by a placement stability calculation method to be described later may be used.

As to the placement stability of the object, a single numeric value is set to a single object. Otherwise, a numeric value of the placement stability may be set to each part of the object. Taking an example in which a drink in a plastic bottle shape is placed vertically with its cap oriented upward, the plastic bottle can fall with a low possibility even when the end effector comes into contact with its bottom or the vicinity of the bottom while the plastic bottle can fall with a high possibility when the end effector comes into contact with the cap or the vicinity of the cap. It can be said that as to the plastic bottle, the placement stability is higher in the vicinity of the bottom than in the vicinity of the cap. In such a case, the numeric value of the placement stability may be set to each part of the single object. In this manner, numeric values of the placement stability of the object may be defined so as to be distributed in the three-dimensional space.

Moreover, even as to the same object, the numeric value of the placement stability may vary depending on an attitude where such an object is placed. For example, the numeric value of the placement stability may be set to vary between a case where the plastic bottle is placed horizontally and a case where the plastic bottle is placed vertically.

The map information integration unit 44 integrates the initial map generated by the map information retaining unit 41 and the information about the placement stability of each object output from the placement stability calculation unit 43 so as to generate a weighting map. Specifically, the corresponding placement stability information is integrated to each object in the initial map generated by the map information retaining unit 41. The weighting map generated by the map information integration unit 44 is output to the operation planning unit 45.

The placement stability information of the object is reflected as a weight defined in a space (region) centered at each object. FIG. 4 shows an example of weights defined in the operation region.

FIG. 4 corresponds to a plan view as the interior of the storage 11 of the refrigerator 10 shown in FIG. 1 is viewed from above. The movement of the end effector can be controlled in a two-dimensional plane or a three-dimensional space. In the following descriptions using diagrams, for the sake of convenience, a trajectory of the end effector that operates in the two-dimensional plane will be taken as an example. Also in generation of a trajectory in the three-dimensional space, a weighting map can be used in a similar way to generation of a trajectory in the two-dimensional plane.

In FIG. 4, the dot density becomes higher as the weight (W) becomes higher. As to the placement stability of the object, the numeric value of the weight is set to become lower as the stability becomes higher.

In FIG. 4, an object denoted by the reference sign 20 is the target object 20 to be gripped by the end effector. The operation region 13 is formed by first object 21a and 21b, the in-refrigerator bottom surface 22a, the in-refrigerator side surfaces 22b, the in-refrigerator top surface 22c, and the target object 20. It should be noted that in a case where it is unnecessary to distinguish them as the first objects 21a and 21b, they referred to as first objects 21. The in-refrigerator bottom surface 22a, the in-refrigerator side surfaces 22b, and the in-refrigerator top surface 22c are the first objects.

The in-refrigerator bottom surface 22a positioned horizontally in a flat form and the in-refrigerator side surfaces 22b corresponding to inner walls of the storage 11 are objects whose positions are fixed and have stability, and the weight of the placement stability is set to be lower for these objects. The first object 21a whose position is variable has a rectangular parallelepiped shape and has stability in terms of its shape, and the weight of the placement stability is set to be relatively slightly lower. On the other hands, the first object 21b whose position is variable has an elongated and tall triangular columnar shape and has lower stability in terms of the shape, and the weight of the placement stability is set to be relatively higher.

The weighting map is a map obtained by reflecting weighting of the placement stability information of each of the objects forming the operation region 13 on the initial map.

The operation region 13 is weighted on the basis of the placement stability information of each object. In the operation region 13, centered at each object, the weight of the placement stability corresponding to the object is defined in a space (region) near the object and the weight of the space (region) is defined so that the weight becomes lower as the object becomes further. How to change the weight may be based on some function such as a linear function and a power function, and the weight may be, for example, changed discretely. In FIG. 4, the example in which the weight is changed discretely is shown.

In the example shown in FIG. 4, a region near the first object 21a whose placement stability is set to be relatively higher is defined to have a lower weight. In the figure, the dot density is higher. A region near the first object 21b whose placement stability is set to be lower is defined to have a higher weight. In the figure, the dot density is lower. Moreover, a region near the in-refrigerator side surfaces 22b whose placement stability is set to be higher is defined to have a lower weight. In the figure, the dot density is higher. In addition, the weight defined for the operation region 13 changes in accordance with a distance from each first object. Moreover, in a case where a plurality of first objects is positioned adjacent to each other, the weight defined for the operation region 13 changes, also affected by placement stability of other first objects.

It should be noted that the weight reflected on the weighting map may be changed in accordance with constraint conditions. For example, a very high weight is set to a region in which no objects should be placed. Accordingly, objects can be prevented from being placed in that space.

The operation planning unit 45 determines an operation of the robot plan on the basis of the weighting map generated by the map information integration unit 44. The operation planning is determining a target reaching position and generating a trajectory of the end effector and trajectories of the target angles of the respective joints from a certain position to the target reaching point in accordance with a given target task. In an example of a carrying-out task of taking the target object out of the refrigerator, the target reaching point is set to be a position at which the target object has been placed.

The trajectory of the manipulator 53 planned by the operation planning unit 45 is output to the movement control unit 46.

Using the trajectory generated by the operation planning unit 45, the movement control unit 46 calculates a control parameter for controlling the movement of the robot 5.

Specifically, the movement control unit 46 calculates acceleration, torque, speed, and the like required for driving of the joint drive unit 81 of each joint 54 in order for the robot 5 to follow the trajectory generated by the operation planning unit 45. The movement control unit 46 calculates acceleration, torque, speed, and the like required for driving of the end effector drive unit 82. The movement control unit 46 calculates acceleration, torque, speed, and the like required for the movement portion drive unit 83 that controls the position of the robot 5 itself. The thus calculated control parameter is sent to the robot 5.

A specific example of trajectory generation (operation plan) will be described.

((Trajectory Generation Method Example 1)) In general, the trajectory of the robot that moves from the first position to the second position that is the target reaching point is planned so as to avoid a collision with an object that is an obstacle and secure a space to the object. That is, trajectories of the end effector and the joints are planned considering a weight depending on the distance to the object. It should be noted that the object that is the obstacle corresponds to the first object in the present embodiment.

On the other hands, in the present embodiment, as described above, weighting of the operation region (space) in which the manipulator 53 operates is performed using the placement stability of the object in addition to the weight depending on the distance to the object. A trajectory of the manipulator 53 is generated using a map reflecting the weighting of the information about the placement stability of such an object. Accordingly, such a trajectory to avoid contact with the unstable first object as much as possible can be generated.

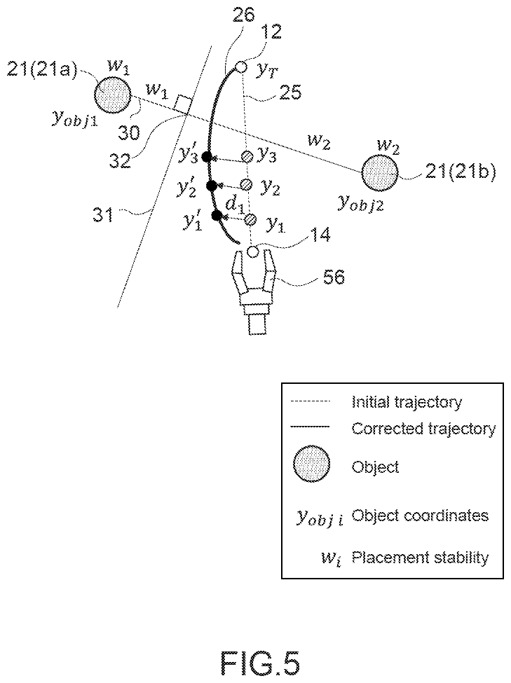

It will be described specifically with reference to FIG. 5. Here, a trajectory of the end effector will be taken as an example.

FIG. 5 is a diagram describing a generation method for a trajectory on which the end effector 56 passes through the gap between the two first objects 21a and 21b adjacent to each other and reaches a second position 12 that is a final target reaching point from a first position 14 that is a current position. FIG. 5 shows a method of correcting the shortest trajectory from the first position to the second position in consideration of the placement stability of the first objects 21a and 21b and generating a corrected trajectory.

In FIG. 5, y_{obj1} denotes object coordinates of the first object 21a, y_{obj2} denotes object coordinates of the first object 21b, and yᵢ (i=1, 2, 3 . . . r) denotes coordinates of the target reaching point. y_{T} denotes the final target reaching point. w1 denotes a numeric value of the weight of the placement stability of the first object 21a and w2 denotes a numeric value of the weight of the placement stability of the first object 21b. In the example shown in the figure, w1<w2 is established, and the first object 21a has placement stability higher than the first object 21b. In the figure, the dotted line shows a trajectory (hereinafter, referred to as initial trajectory) generated by a conventional method and the solid line shows a trajectory (hereinafter, referred to as “corrected trajectory” or simply referred to as “trajectory”) generated by a trajectory generation method example 1.

The trajectory Ω is a set of target reaching points yᵢ. The point “yᵢ” is two-dimensional or three-dimensional coordinates and it is a vector value. First of all, an initial trajectory 25 connecting the current position (first position) 14 of the end effector 56 and the final target reaching point (second position) y_{T} is calculated. The initial trajectory 25 is expressed by the expression below.

Ω=(y₁,y₂ . . . y_{T}) [Expression 1]

Next, each target reaching point yᵢ is corrected on the basis of the placement stability of adjacent objects (the first objects 21a and 21b in the example shown in FIG. 5) as shown in the expression below. Where dᵢ denotes the amount of correction.

y′ᵢ=yᵢ+dᵢ [Expression 2]

The corrected trajectory Ω′ is expressed by the expression below.

Ω′=(y′₁,y′₂ . . . y′_{T}) [Expression 3]

An absolute value of the amount of correction dᵢ above is changed over time as shown in the expression below. It is because it is necessary for the end effector 56 to reach the final target reaching point at a time T. The absolute value of dᵢ is set to become smaller around the time T.

|dᵢ|=h(t) [Expression 4]

dᵢ is calculated by the expression below so as to be corrected in a direction further from an unstable first object and closer to a stable first object.

dᵢ=f(w₁,w₂,yᵢ,y_{obj1},y_{obj2}) [Expression 5]

(Note that |dᵢ|=h(t) should be satisfied.)

A specific example of a calculation method according to the expression above is as follows.

As shown in FIG. 5, an internally dividing point 32 that divides a line segment 30 connecting the two first objects 21a and 21b as w1:w2 is set and a perpendicular virtual line 31 is drawn on the line segment 30 passing the internally dividing point 32. A corrected trajectory 26 is generated by an optimization method so that coordinates y′i after the movement becomes the closest to the virtual line 31. As shown in FIG. 5, y′i is set so as to be closer to the virtual line 31.

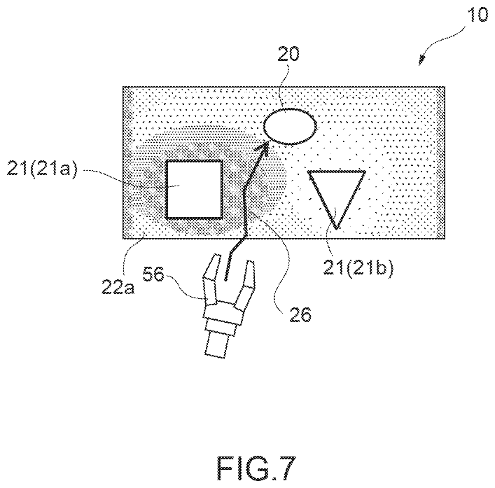

By the trajectory generation method as described above, the trajectory (corrected trajectory) 26 is generated as shown in FIG. 7.

### ((Trajectory Generation Method Example 2))

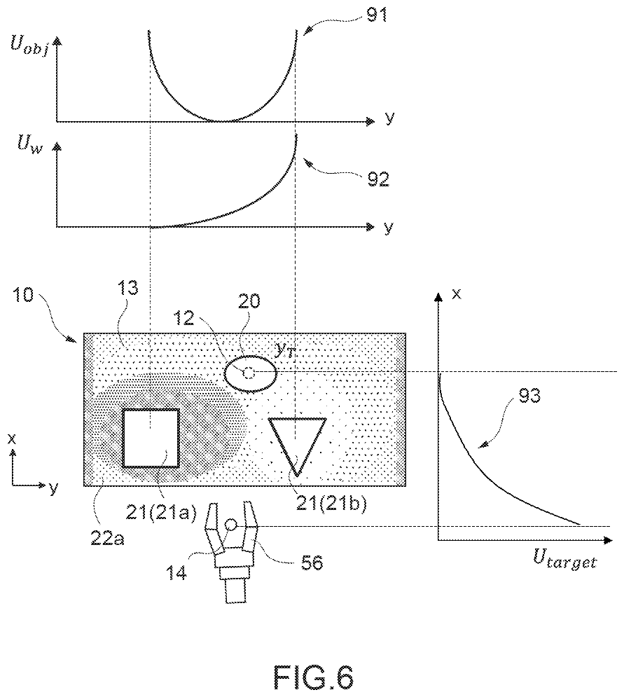

Another trajectory generation example will be described with reference to FIG. 6. FIG. 6 is a diagram describing a generation method for the trajectory on which the end effector 56 passes through the gap between the two first objects 21a and 21b adjacent to each other and reaches a second position 12 that is a final target reaching point from a first position 14 that is a current position. It is assumed that the target object 20 is positioned at the second position 12. FIG. 6 is a plan view (xy-plan view) showing how the first objects 21a and 21b and the target object 20 are placed on the in-refrigerator bottom surface 22a inside the refrigerator as viewed from above. The xy-plane is a horizontal plane and the x-axis denotes a depth direction of the refrigerator. The y-axis is orthogonal to the x-axis. It is assumed that the first object 21a has higher placement stability than the first object 21b.

A trajectory generation method example 2 is a method in which a map reflecting the placement stability of the object is handled as a potential field, a gradient of the potential field is determined, a trajectory is calculated in such a direction that the gradient becomes minimum, and the trajectory is used as a corrected trajectory. Here, generation of the trajectory of the end effector 56 will be taken as an example.

In FIG. 6, a curve line 91 shows a potential field U_{obj} corresponding to a distance to the first object between the first objects 21a and 21b positioned in the y-axis direction in the operation region 13. A potential field shown as the curve line 91 is set to become maximum near the first objects 21a and 21b and the potential field is set to become smaller as the first object becomes further. In the example shown in FIG. 6, the curve line 91 is in a catenary curve shape in which the potential field at a position corresponding to a middle point between the first objects 21a and 21b becomes smaller and the potential field becomes larger as it becomes closer to each first object.

In FIG. 6, a curve line 92 shows a potential field U_{w} based on the placement stability of the first objects 21a and 21b between the first objects 21a and 21b positioned in the y-axis direction in the operation region 13. In the example shown in FIG. 6, the first object 21a has higher placement stability than the first object 21b. Therefore, as to the curve line 92, the potential field becomes larger as it becomes closer to the first object 21b from the first object 21a. In the figure, it is a curve line upward to the right.

In FIG. 6, a curve line 93 shows a potential field U_{target} from the first position 14 to the second position (target reaching point) 12 in the x-axis direction in the operation region 13. A potential field shown as the curve line 93 is set to become minimum at the target reaching point. In the example shown in FIG. 6, as to the curve line 93, the potential field becomes larger as it becomes forward from the deeper side in the x-axis direction. In the figure, it is a curve line shape upward to the left.

In this example, a potential field U is determined by adding up the above-mentioned three potential fields as shown in the expression below.

U=U_{obj}+U_{w}+U_{target} [Expression 6]

As shown in the expression below, the target position of the end effector is updated in a direction in which the gradient of the potential field U decreases. In the following expression, yₜ denotes a current position (vector) of the end effector. yₜ₊₁ denotes a next target position (vector). η denotes an updated width.

$${y}_{t + 1} = {y}_{t} - η \frac{\partial U}{\partial y} \begin{matrix}{y}_{t} : Current position ( vector ) \\ {y}_{t + 1} : Next target position ( vector ) \\ η : Updated width\end{matrix} \qquad [ Expression 7 ]$$

The trajectory of the end effector Ω is expressed by the expression below. In order to generate a smoother trajectory, it is sufficient to reduce η.

Ω=(y₀,y₁ . . . y_{T}) [Expression 8]

By the trajectory generation method described above, the trajectory 26 is generated as shown in FIG. 7.

Moreover, the operation planning unit 45 may generate a trajectory that varies depending on the kind of target task.

For example, for taking out a target object located on the shelf of the refrigerator, the position of the end effector 56 is important in a case where the target object is located in front and the first object is not located in front of the target object. Therefore, the operation planning unit generates a trajectory of the position of the end effector 56.

On the other hand, in a case where the target object is located on the deep side and the first object is located in front of the target object, there is a possibility that the joints 54 and the links 55 of the manipulator 53 is brought into contact with the first object before the end effector 56 is moved to the final target reaching point. In a case where such a target object is located on the deep side and the first object is located in front of the target object, the operation planning unit 45 also plans trajectories of the target angles of the joints that define the attitude of the entire manipulator 53 that operates in the operation region 13 in addition to the trajectory of the position of the end effector 56.

Here, the terms “front” and “deep” represent the position relationship as the storage 11 of the refrigerator 10 is viewed from the side of the robot 5.

As described above, on the basis of the map reflecting weighting based on the placement stability information of the first object, the control unit 4 plans the operation of the manipulator 53 (trajectories of the end effector 56 and the target angles of the joints 54). The end effector 56 and the joints 54 are driven on the basis of the trajectories. Therefore, the movement of the manipulator 53 can be controlled to avoid contact with a more unstable object as much as possible. Accordingly, the occurrence of fall, collapse, breakage, and the like of the object due to the contact of the manipulator 53 can be suppressed, and an operation suitable for the surrounding environment of the manipulator can be performed.

Moreover, such a trajectory that the contact with the object is inevitable has to be taken depending on a placement state of the object that forms the operation region. Also in such a case, a trajectory is generated using the map reflecting weighting based on the placement stability information of the object, and the occurrence of fall, collapse, breakage, and the like of the object due to the contact can be accordingly suppressed as much as possible.

### ((Calculation Method for Placement Stability))

Next, a calculation method for the placement stability of the object will be described.

The following calculation methods can be applied to placement stability calculation in both two dimensions and three dimensions. Placement stability can be calculated in advance. Placement stability information of each object calculated by each of the following calculation methods for each object is generated by humans as a database in advance and stored in the storage unit.

A contact area of an object with a horizontal and flat placement surface when the object is placed on the placement surface, for example, the in-refrigerator bottom surface 22a can be estimated and placement stability can be calculated in accordance with the contact area.

Placement stability can be calculated on the basis of a material of the object. For example, placement stability of objects fragile in a fall, such as bottles, may be set to be higher and placement stability of objects not fragile in a fall, such as cans, may be set to be lower.

A friction coefficient can be calculated on the basis of the material of the object and placement stability can be calculated in accordance with the value.

Placement stability can be calculated on the basis of the shape of the object. For example, spherical shapes have relatively lower placement stability and rectangular parallelepiped shapes have higher placement stability.

The placement stability can be calculated on the basis of an aspect ratio and an angle of inclination of the object and a contact state with the other object (e.g., objects whose positions are fixed, such as the in-refrigerator bottom surface 22a and the in-refrigerator side surfaces 22b, and objects whose positions are variable, such as food products).

The placement stability can be calculated in accordance with rigidity of the object. For example, a change in shape of the object over time is known from a sensing result of the tactile sensor when the object is gripped by the use of the end effector, and the rigidity of the object can be estimated on the basis of a reaction force and a gripping depth determined on the basis of a change in shape of the object over time. The rigidity can be considered to be lower as the reaction force from the object is larger, and the placement stability can be set so that the placement stability becomes higher as the reaction force becomes larger.

On the basis of the past manipulation result information, a fall rate, a collapse rate, or a breakage rate of the object can be determined and the placement stability of the object can be calculated.

A deformation rate of the object when the robot comes into contact with the object can be observed and placement stability depending on the deformation rate can be calculated. For example, the deformation rate of the object can be observed on the basis of a sensing result of the tactile sensor when the object is gripped by the use of the end effector.

The placement stability of the object stored in the storage unit may be determined by using any one of indications calculated by the above-mentioned calculation method or may be determined by using a plurality of indications.

An example of totally calculating final placement stability using a plurality of indications will be taken. Placement stability calculated on the basis of a shape is denoted by wₚᵣᵢₘᵢₜᵢᵥₑ, placement stability calculated on the basis of a friction coefficient is denoted by w_{friction}, placement stability calculated on the basis of rigidity of the object is denoted by w_{stiffness}, and placement stability determined on the basis of past manipulation result information is denoted by wₚᵣₑᵥ. Final placement stability w is determined in accordance with the expression below. In such an expression, α1, α2, α3, and β are coefficients and set in accordance with a degree of importance of respective placement stability.

w=(1−β)(α₁wₚᵣᵢₘᵢₜᵢᵥₑ+α₂w_{friction}+α₃w_{stiffness})+βwₚᵣₑᵥ [Expression 9]

It should be noted that the numeric value of the placement stability may be a continuous value or may be a discrete value.

Moreover, an average value, a minimum value, and a maximum value of placement stability of a similar object, which are calculated in the past, may be used. In a case where the average value is used, it has an effect of reducing an influence caused by an individual difference. In a case where the minimum value is used, the worst case of the object is considered. Therefore, a trajectory with a higher safety rate at which fall, collapse, and breakage of the object are less likely to occur can be calculated.

Those calculation methods may change depending on the kind of object or task. For example, in a case where the object includes an expensive object, an offset may be applied to the above-mentioned calculation result or the above-mentioned calculation result may be multiplied with a safety rate. Accordingly, it is possible to operate the robot more carefully, evaluating the placement stability of the object to be generally lower. In this manner, object value information may be considered in addition to the placement stability information of the object.

### ((Control Method))

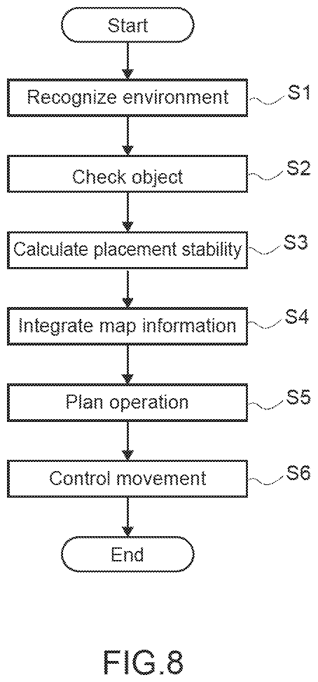

A control method (processing flow) performed by the control unit 4 will be described with reference to FIG. 8.

As shown in FIG. 8, the environment recognition unit 40 recognizes the surrounding environment of the robot on the basis of the sensing result (image information) acquired by the vision sensor (S1). In recognition of the surrounding environment, recognition objects located in the periphery of the robot for example is performed. The map information retaining unit 41 generates an initial map on the basis of a processing result in the environment recognition unit 40.

Next, the placement stability calculation unit 43 checks an object recognized by the environment recognition unit 40 against the database stored in the storage unit 42 (S2), and calculates placement stability of the object (S3).

Next, the map information integration unit 44 generates a weighting map integrated by the initial map generated by the map information retaining unit 41 and the placement stability information of each object calculated by the placement stability calculation unit 43 (S4).

Next, the operation planning unit 45 generates a trajectory of the manipulator 53 on the basis of the weighting map (S5).

Next, the movement control unit 46 calculates a control parameter of the robot 5 so that the movement of the manipulator 53 follows the trajectory generated by the operation planning unit 45 (S6).

As described above, in the present embodiment, the movement of the manipulator is controlled using the map of the operation region reflecting weighting based on the placement stability information of the surrounding objects that form the operation region of the manipulator. Accordingly, the occurrence of fall and breakage of the surrounding objects due to the contact of the manipulator can be suppressed, and the movement of the manipulator can be made suitable for the surrounding environment.

For example, in an environment in which a plurality of objects is randomly placed, the manipulator can grip and moves only a desired target object without dropping or breaking the objects. Moreover, a trajectory can be generated so as to avoid an unstable object in placement by using the weighting map. Accordingly, the manipulator can be moved quickly and safely.

### Modified Example 1

In a case where there is not a sufficient database regarding the placement stability information of the object, the possibility that the manipulator may come into contact with the object during operation increases due to the information insufficiency. In such a case, it can be addressed by using the first sensor mounted on the manipulator, calculating placement stability of the object on the basis of a sensing result of the first sensor obtained when actually the object comes into contact with the manipulator, and updating the map information as necessary.

Hereinafter, a specific example will be taken.

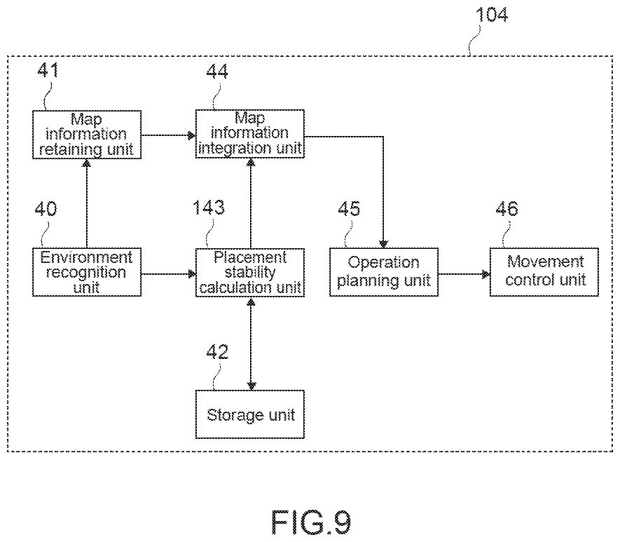

FIG. 9 is a functional configuration block diagram of a control unit 104 according to Modified Example 1.

As shown in FIG. 9, the control unit 104 has an environment recognition unit 40, a map information retaining unit 41, a storage unit 42, a placement stability calculation unit 143, a map information integration unit 44, an operation planning unit 45, and a movement control unit 46.

As in the placement stability calculation unit 43 of the control unit 4, the placement stability calculation unit 143 calculates a numeric value of the placement stability of the first object subjected to object recognition by using the surrounding environment information obtained by the processing in the environment recognition unit 40 and the table stored in the storage unit 42.

In addition, in a case where the contact of the object with the manipulator occurs as a result of operating of the manipulator 53 according to the generated trajectory, the placement stability calculation unit 143 calculates placement stability of the object in contact by using a sensing result of the first sensor (the tactile sensor 72 and the force sensor 73).

It should be noted that whether or not the manipulator 53 comes into contact with the object can be determined on the basis of sensing results at sensors such as the vision sensor 71, the tactile sensor 72, and the force sensor 73. The determination as to whether or not the manipulator 53 comes into contact with the object may be performed at the control apparatus 2 or may be performed at the robot 5.

A reaction force from the object can be measured from a sensing result at the first sensor, which is detected when the manipulator comes into contact with the object. In measurement of the reaction force, an external force added to the contact position is estimated using the force sensor. Otherwise, the reaction force is measured directly from the tactile sensor. Placement stability of the object can be calculated in accordance with the magnitude of the reaction force. It has higher placement stability as the reaction force becomes larger.

Hardness (rigidity) of the object can be estimated on the basis of a reaction force and a gripping depth determined from a sensing result at the tactile sensor when the object is gripped by the use of the end effector. Placement stability of the object can be calculated in accordance with the hardness.

A friction coefficient of the object can be estimated on the basis of slipperiness determined from the sensing result at the tactile sensor when the manipulator comes into contact with the object or when the object is gripped by the use of the end effector. Placement stability of the object can be calculated in accordance with the friction coefficient.

Surface roughness, shape, and the like of the object can be estimated on the basis of a contact distribution between the end effector and the object, the contact distribution being determined on the basis of the sensing result at the first sensor at the time of contact between the object and the end effector. For example, a shape can be estimated on the basis of a change in pressure distribution over time when the contact occurs. Taking an example in which an object with a liquid matter stored in a bag made of a flexible material is gripped, the shape of such an object changes easily and the pressure distribution fluctuates easily. The shape of the object can be estimated on the basis of a change in pressure distribution when the contact occurs in this manner, and the placement stability of the object can be calculated.

An amount of movement and a change in attitude of the object can be detected from a sensing result at the first sensor and image information acquired the vision sensor when the manipulator comes into contact with the object. For example, in a case where the amount of movement of the object at the time of contact is larger than the amount of movement of the robot, it can be determined that the object has fallen as a high possibility and the placement stability is low. Moreover, in a case where the attitude of the object at the time of contact is tilted, it can be determined that the fall possibility is high and the placement stability is low.

The placement stability of the object may be determined by using any of the indication calculated by the calculation method described above and the final placement stability may be determined totally by using the plurality of indications.

Moreover, in a case where the plurality of objects is stacked, placement stability for each object for example may be calculated and the lowest value of the calculated numeric values may be considered as total placement stability of the stack in which the plurality of objects is stacked.

Moreover, the placement stability calculation unit 143 may estimate a primitive shape of the object on the basis of the sensing result of the vision sensor (image information) and calculate approximate placement stability of the object. Moreover, on the basis of the sensing result of the vision sensor, information such as an aspect ratio and an angle of inclination of the object, a contact state with the other object, and the contact area with the other object can be obtained in addition to the primitive shape of the object, and placement stability may be calculated in view of such information. It should be noted that the placement stability calculation unit 143 may calculate placement stability by using both the sensing result of the vision sensor and the sensing result of the first sensor.

Since the placement stability of the object can also be calculated on the basis of the primitive shape of the object in this manner, detailed information of the object is not essential. Immediately after the detailed information is obtained, the information about the placement stability in the database can be updated.

In a case where the manipulator comes into contact with the object, it is possible to calculate placement stability again by the above-mentioned method, more correctly correct the placement stability associated with the object whose information is insufficient, and update the database. Accordingly, the possibility of the occurrence of fall, collapse, breakage, and the like of the object can be further reduced. Moreover, also for an object whose information is obtained in advance, placement stability can be calculated by using the sensing result of the vision sensor as described above.

As to the placement stability calculated by using at least one of the sensing result of the vision sensor and the sensing result of the first sensor, the placement stability previously saved in the table may be overwritten completely or may be updated at a constant rate by multiplying it with a coefficient. For updating at the constant rate, for example, final placement stability can be calculated by using the expression below.

w=γw_{table}+(1−γ)wₛₑₙₛₒᵣ [Expression 10]

Where w_{table} denotes the placement stability stored in the storage unit 42. wₛₑₙₛₒᵣ denotes placement stability calculated by the placement stability calculation unit 143 by using at least one of the sensing result of the vision sensor and the sensing result of the first sensor. γ denotes a coefficient.

### ((Control Method))

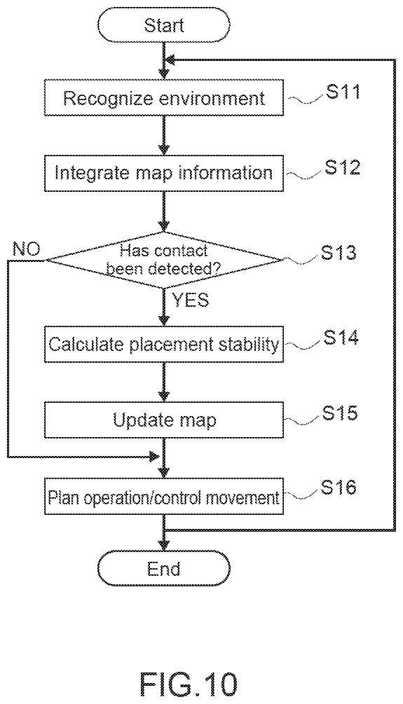

An example of the control method (processing flow) using the sensing result of the first sensor, which is performed by the control unit 104, will be described with reference to FIG. 10.

As shown in FIG. 10, the environment recognition unit 40 recognizes a surrounding environment of the robot on the basis of a sensing result (image information) acquired by the vision sensor (S11). In the recognition of the surrounding environment, an object located in the periphery of the robot for example is recognized. The map information retaining unit 41 generates an initial map on the basis of a processing result at the environment recognition unit 40. Moreover, the placement stability calculation unit 143 checks the object recognized by the environment recognition unit 40 against the database stored in the storage unit 42 and calculates placement stability of the object.

Next, the map information integration unit 44 integrates placement stability information of each object, which is calculated on the basis of the initial map generated by the map information retaining unit 41 and the placement stability calculation unit 143, and generates a weighting map (S12). The operation planning unit 45 generates a trajectory of the manipulator 53 on the basis of the weighting map. The manipulator of the robot 5 operates in accordance with the trajectory.

Next, whether or not the manipulator comes into contact with the object is determined (S13). When it is determined that contact occurs, the processing shifts to S14. When it is determined that contact does not occur, the processing shifts to S16.

In S14, the placement stability calculation unit 143 calculates placement stability of the object in contact by using the sensing result of the first sensor.

Next, the map information integration unit 44 updates the weighting map by using the placement stability calculated in S14 (S15).

Next, the operation planning unit 45 generates a trajectory of the manipulator 53 on the basis of the updated weighting map. The movement control unit 46 calculates a control parameter of the robot so that the trajectory generated by the operation planning unit 45 follows the movement of the manipulator 53 (S16).

Next, the processing is repeated by returning to S11.

As described above, the placement stability information of the object can be updated by using the sensing result of the first sensor, which is acquired at the time of contact of the manipulator with the object, the occurrence of fall and breakage of the surrounding objects due to the contact of the manipulator can be further suppressed, and the movement of the manipulator can be made suitable for the surrounding environment.

It should be noted that although the case where there is not a sufficient database regarding the placement stability information of the object has been as an example here, it can also be applied to a case where there is not any information regarding the placement stability of the object. That is, the object is actually gripped, and the placement stability of the object can be calculated on the basis of the sensing result obtained by the first sensor at that time and the sensing result of the vision sensor (visual information). By using the weighting map reflecting the calculated placement stability, the movement of the manipulator can be made suitable for the surrounding environment and safe.

Moreover, even in a case where there is a large individual difference between objects or in a case where accurate placement stability cannot be calculated on the basis of the sensing result of the vision sensor (visual information), the movement of the manipulator can be controlled while correcting the placement stability by using the sensing result of the first sensor. Therefore, it is safer.

### Modified Example 2

In the above description, the movement when the carrying-out task is provided has been mainly described. Here, the movement when a carrying-in task of placing the target object located at the position outside the refrigerator 10 at the position in the refrigerator 10 is provided will be described. In this manner, the robot 5 is capable of performing not only a task of taking out a target object but also a task of placing a target object.

A flow of the carrying-in task is as follows. That is, the end effector 56 of the manipulator 53 grips a target object located outside the refrigerator 10. Next, the end effector 56 moves from the position A (first position) outside the refrigerator 10 to the position B (second position) that is a target reaching point inside the refrigerator 10. Next, the end effector 56 releases the gripped state and places the target object at the position B. Next, the end effector 56 moves to the position C (second position) outside the refrigerator 10 from the position B (first position).

In this carrying-in task, a weighting map is planned on the basis of the trajectory from the position A to the position B and the trajectory from the position B to the position C through which the end effector 56 passes. In addition, trajectories of the target angles of the respective joints as well as the trajectory of the end effector are planned. Besides, a target reaching point at which the target object is placed is determined on the basis of the map weighting.

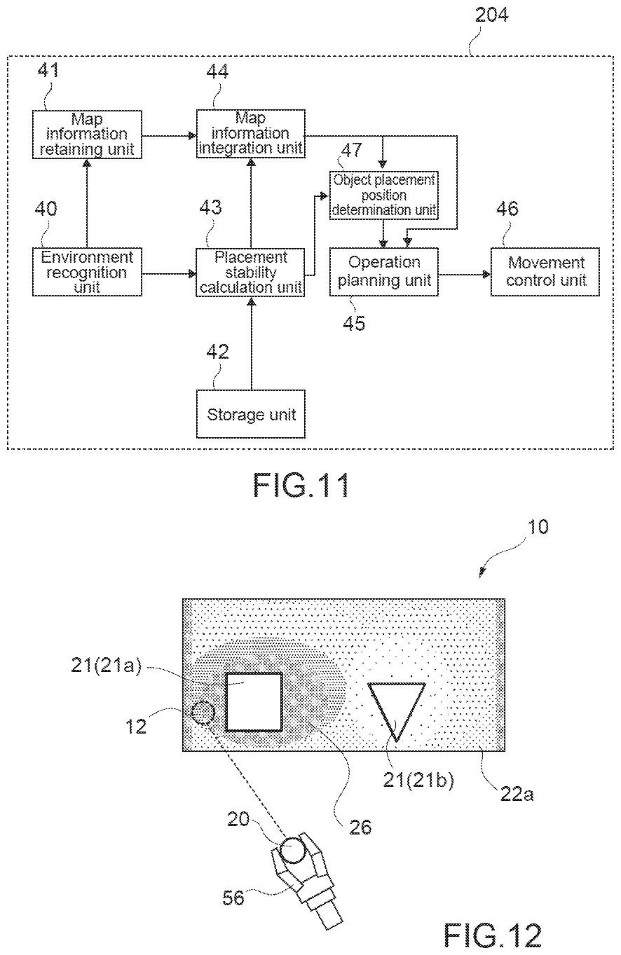

FIG. 11 is a functional configuration block diagram of a control unit 204 according to Modified Example 2.

FIG. 12 shows how the manipulator 53 places the target object 20 inside the refrigerator 10.

As shown in FIG. 11, the control unit 204 has an environment recognition unit 40, a map information retaining unit 41, a storage unit 42, a placement stability calculation unit 43, a map information integration unit 44, an operation planning unit 45, a movement control unit 46, and an object placement position determination unit 47.

The object placement position determination unit 47 determines a target reaching point at which the target object 20 is placed on the basis of the map weighting generated by the map information integration unit 44. For example, on the basis of the map weighting, the target reaching point can be set in a region whose weight of the placement stability is lower, and the target object 20 can be placed in a stable region.

In addition, the object placement position determination unit 47 may determine a target reaching point in view of the placement stability information of the target object.

For example, in a case where the placement stability of the target object is relatively lower, placing the target object near the first object having higher placement stability lowers a danger possibility that both may fall. Also, it lowers a danger possibility that the first object may fall even if it comes into contact with the first object during the placement task.

On the other hand, in a case where the target object has relatively higher placement stability, a danger possibility that both may fall even if the target object is placed next to the first object having lower stability is lower.

In the example shown in FIG. 12, the target object 20 has a spherical shape and has lower placement stability. In such a case, the object placement position determination unit 47 sets a region in which the weight of the placement stability is defined to be lower as a target reaching point 12.

An example of a method of determining a placement position, i.e., a target reaching point for the target object by the object placement position determination unit 47 will be shown.

The placement stability of the target object 20 currently gripped by the end effector 56 is denoted by w_{grasp} and the weight of the operation region (surrounding environment) calculated on the basis of the placement stability is denoted by wₑₙᵥ(x, y, z). x, y, z denote coordinates in the environment and are coordinates defined in the map information. A suitable placement location (x, y, z), i.e., a favorable target reaching point can be calculated by defining a certain threshold wₜₕᵣₑₛₕ and determining x, y, z satisfying the condition of the expression below.

w_{grasp}·wₑₙᵥ(x,y,z)<wₜₕᵣₑₛₕ [Expression 11]

Otherwise, as another determination method, a point that minimizes a product of the placement stability of the target object 20 currently gripped and the weight of the operation region (surrounding environment) may be selected by using the expression below and it may be set as the target reaching point.

$${x}^{′} , {y}^{′} , {z}^{′} = \begin{matrix}argmin \\ x , y , z\end{matrix} {w}_{grasp} \cdot {w}_{env} ( x , y , z ) \qquad [ Expression 12 ]$$

In this manner, the target reaching point, which is a placement position for the target object, can be adjusted. Therefore, the occurrence rate of a failure such as fall and breakage of the first object can be reduced.

### Modified Example 3

In addition to the configuration of the above-mentioned embodiment, a control parameter for controlling the movement of the manipulator, more specifically, a control gain may be changed on the basis of the placement stability of the object. For example, in a case where the robot 5 performs impedance control, even if the manipulator comes into contact with the object when moving the manipulator in the periphery of the object having lower placement stability, the gain of the impedance control can be reduced in order to prevent an excessive force at the contact point from being produced. Accordingly, the movement of the manipulator can be made a soft movement conforming to the object, and the influence due to the contact can be minimized.

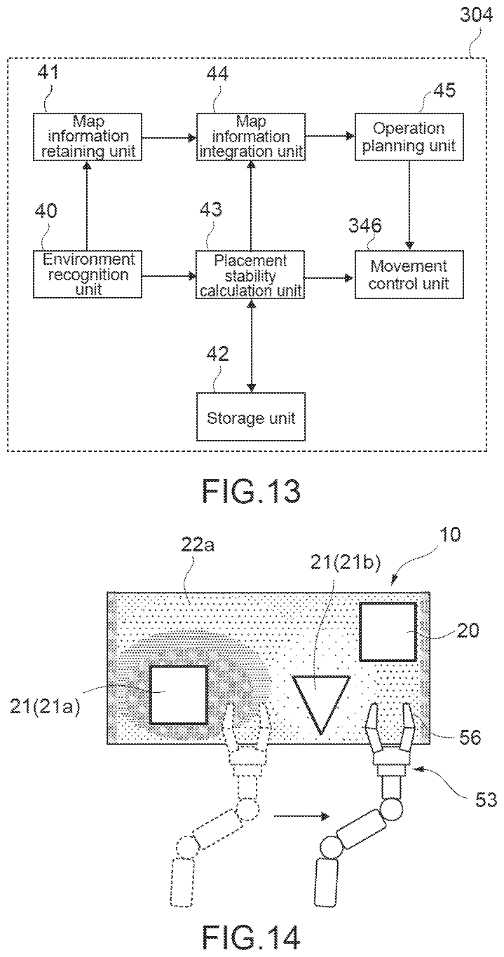

FIG. 13 is a functional configuration block diagram of a control unit 304 according to Modified Example 3.

As shown in FIG. 13, the control unit 304 has an environment recognition unit 40, a map information retaining unit 41, a storage unit 42, a placement stability calculation unit 43, a map information integration unit 44, an operation planning unit 45, and a movement control unit 346.

The movement control unit 346 calculates acceleration, torque, speed, and the like required for driving of the joint drive unit 81 of each joint 54 so that the robot 5 follows the trajectory generated by the operation planning unit 45. The movement control unit 346 calculates acceleration, torque, speed, and the like required for driving of the end effector drive unit 82. The movement control unit 346 calculates acceleration, torque, speed, and the like required for the movement drive unit 83 that controls the position of the robot 5 itself. In addition, the movement control unit 346 changes the control gain and calculates control parameters in view of the placement stability information of the object in order to prevent an excessive force at the contact point from being produced even if the manipulator comes into contact with the object when calculating these control parameters. The thus calculated control parameters are sent to the robot 5.

By changing the control parameters of the robot in view of the placement stability of the object in this manner, the influence due to the contact can be minimized.

Moreover, the control parameters can be changed in accordance with the placement stability. Therefore, the manipulator can be controlled so that an operation of, for example, gripping the target object in contact with the object can be performed. Accordingly, also in a case where it is difficult to move the manipulator without coming into contact with an object because objects are placed at high density, the manipulator can be moved stably while suppressing the occurrence of fall, breakage, and the like of the object.

### Modified Example 4

In addition to the configuration of the above-mentioned embodiment, the position and attitude of the robot may be changed in view of the placement stability of the object. For example, in a case where the manipulator 53 attempts to take a target object located on the deep side of the refrigerator and comes into contact with the first object located in front of the target object, limited conditions of the position and attitude, which the robot takes, to move the contact portion away from the object may be added to the control.

Accordingly, even if the manipulator comes into contact with the object when the manipulator moves on the basis of the generated trajectory, placement stability of the object in contact can be calculated immediately on the basis of the contact information, and the manipulator can perform a recovery operation on the basis of the calculated placement stability. The recovery operation refers to, for example, such an operation to release the force in a case where it comes into contact with the object.

Moreover, as shown in FIG. 14, a gripping target object 20 located on the deep side of the refrigerator 10 is separated from the current position (shown as the dotted line) of the manipulator 53. Moreover, in a case where the first object 21b having lower placement stability is located near, the entire robot 5 may be controlled to move so that the manipulator 53 is located at a position easy to take the target object 20. Otherwise, the attitude of the entire manipulator may be in such a form that it does not come into contact with the other object.

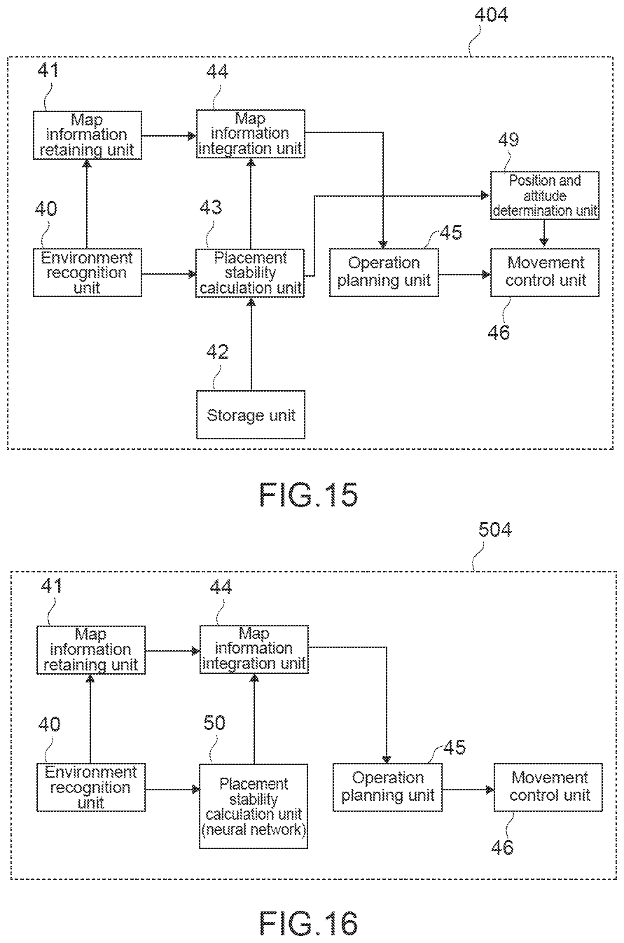

FIG. 15 is a functional configuration block diagram of a control unit 404 according to Modified Example 4.

As shown in FIG. 15, the control unit 404 has an environment recognition unit 40, a map information retaining unit 41, a storage unit 42, a placement stability calculation unit 43, a map information integration unit 44, an operation planning unit 45, a movement control unit 46, an object placement position determination unit 47, and a position and attitude determination unit 49.

The position and attitude determination unit 49 determines position and attitude-limited conditions of the entire robot 5 by using the placement stability information of the object calculated by the placement stability calculation unit 43. The determined position and attitude-limited conditions is output to the movement control unit 46. The movement control unit 46 calculates control parameters of the joint drive unit 81, the end effector drive unit 82, and the movement drive unit 83 so as to follow the trajectory generated by the operation planning unit 45 by using the position and attitude-limited conditions determined by the position and attitude determination unit 49. The calculated control parameters are sent to the robot 5.

In this manner, the position and attitude of the entire robot can be changed in accordance with the placement stability of the object. Therefore, the occurrence of fall, breakage, and the like of the object due to the contact of the manipulator can be reduced.

### Modified Example 5

The placement stability of the object may be predicted with a learning model such as a neural network.

FIG. 16 is a functional configuration block diagram of a control unit 504 according to Modified Example 5.

As shown in FIG. 16, the control unit 504 has an environment recognition unit 40, a map information retaining unit 41, a placement stability calculation unit 50 constituted by a neural network, a map information integration unit 44, and an operation planning unit 45, a movement control unit 46.

The placement stability calculation unit 50 is a learning model obtained by learning a relationship between the image information of the object and the placement stability information of the object, for example. The learning model can be learned in advance. For example, a network using the image information as the input and the placement stability of the object as the output is build. The learning model can be learned using data collected from the manipulation result information.

Using the learning model and the sensing result (image information) of the vision sensor 71, the placement stability of the object can be calculated. Using the learning model in this manner, placement stability can be calculated even for objects that have not been recognized ever, by using the versatility of learning.

### Modified Example 6

A configuration in which the placement stability of the object can be updated by using past manipulation result information of the other robot may be employed. With respect to another robot different from the robot 5 and a control unit that controls this other robot, a technology similar to the control system 1 of the robot 5 may be introduced. In view of this, the obtained information of the placement stability of the object may be integrated to generate a weighting map.

Moreover, a database regarding the placement stability information of the object may be configured to be sharable between control units that control different robots. The control units corresponding to the plurality of respective robots are each connected to a server having the database so as to be capable of sending/receiving information, and the database in the server may be updated as necessary by using the past manipulation result information of each robot.

In this manner, more accurate placement stability information of the object can be obtained with a smaller times of tries by using the past manipulation result information of the other robot.

### Modified Example 7

As another task example of the target task described in the above description, there is a replacement task of replacing the target object located inside the refrigerator 10 to another position inside the same refrigerator 10. For example, the replacement task can be performed in a case of performing a replacement plan of the target object on the basis of placement stability of the target object itself located inside the refrigerator 10. For example, in a case where the target object is an unstable object, this replacement task can move it to a more stable place than the current place.

A flow of the replacement task is as follows. That is, the end effector 56 of the manipulator 53 moves from a position A (first position) outside the refrigerator 10 to a position B (second position) inside the refrigerator 10 at which the target object is located. Next, the end effector 56 grips the target object. Next, in a state of gripping the target object, the end effector 56 moves from the position B (first position) to another position C (second position) inside the refrigerator 10. Next, the end effector 56 releases gripping and the target object is replaced to the position C. Next, the end effector 56 moves a position D outside the refrigerator 10 from the position C.

In this task, a trajectory from the position A to the position B, a trajectory from the position B to the position C, and a trajectory from the position C to the position D, through which the end effector 56 passes, are planned on the basis of the weighting map. In addition, trajectories of the target angles of the respective joints are planned in addition to the trajectory of the end effector. In addition, the position C (target reaching position) at which the target object is replaced is determined on the basis of the map weighting.

In this manner, the object can be replaced in consideration of the placement stability of the object. Accordingly, for example, in accordance with the object placement situation at that time, the place of the unstable target object can be changed to a more stable place than the current place.

Embodiments of the present technology are not limited to the above-mentioned embodiment and various changes can be made without departing from the gist of the present technology.

For example, in the above-mentioned embodiment, the example in which the control unit 4, 104, 204, 304, 404, 504 is provided in the external apparatus different from the robot 5, though not limited thereto. It is sufficient that the function of the control unit that controls the operation of the robot can be achieved in the entire control system. As an example, the control unit may be mounted on the robot and the robot itself may function as the control apparatus and the control system. Moreover, some of the plurality of functional configuration blocks constituting the control unit may be provided in the robot and the other functional configuration blocks may be provided in an external apparatus different from the robot. For example, the movement control unit may be provided in the robot and the functional configuration blocks that generates a weighting map and plans a trajectory with the weighting map may be provided in the control apparatus. In this case, the trajectory information planned by the control apparatus may be sent to the robot, and the robot may calculate a control parameter on the basis of the received trajectory information. As a still another example, the storage unit may be provided in the control apparatus and the other functional configuration blocks may be provided on the robot. Here, a configuration in which the database stored in the storage unit may be shared between the plurality of different robots may be employed.

Moreover, in the above-mentioned embodiment, the case where the present technology is mainly applied to the movement of the manipulator has been described taking the type of robot that is movable with the manipulator as an example of the robot, though not limited thereto. The present technology may be applied to movement control of the robot itself. For example, the present technology may be applied to movement control of the robot that works in an atomic power plant that humans are prohibited to enter due to radioactive contamination. Moreover, the present technology may be applied to a robot that is not movable and has a function of the manipulator.

It should be noted that the present technology may also take the following configurations.

(1) A control apparatus, including
a control unit that controls an operation of a robot on the basis of a map of an operation region that reflects weighting of placement stability information of an object that forms the operation region of the robot, the map being generated using surrounding environment information of the robot.

(2) The control apparatus according to (1), in which
the placement stability information of the object is calculated using one or more selected from a contact area of the object with another object, a friction coefficient of the object, a shape of the object, a contact state of the object with another object, rigidity of the object, result information when the robot operates on the basis of the map, and a deformation rate of the object during contact with the robot.

(3) The control apparatus according to (1) or (2), in which
the environment information is information based on a sensing result of a vision sensor and the environment information includes shape information of the object, position information of the object in the operation region, and position relationship information between the robot and the object.

(4) The control apparatus according to any one of (1) to (3), in which
the map is generated using the placement stability information of the object calculated in advance.

(5) The control apparatus according to any one of (1) to (4), in which
the map is generated using the placement stability information of the object calculated using at least one of a sensing result of the first sensor provided in the robot and a sensing result of a vision sensor that acquires the environment information.

(6) The control apparatus according to (5), in which
the placement stability of the object is calculated using at least one of a shape, a size, rigidity, a change in shape over time, and a contact area with another object of the object determined on the basis of at least one of the sensing result of the first sensor and the sensing result of the vision sensor.

(7) The control apparatus according to (5) or (6), in which
the first sensor includes at least one of a force sensor and a tactile sensor.

(8) The control apparatus according to any one of (1) to (7), in which
the robot is provided with a manipulator having a joint, a link that rotates about the joint as a center, and a holding unit that holds or releases a target object, the manipulator being provided at a distal end, and
the control unit controls the operation of the robot on the basis of at least one of a trajectory of the holding unit and a trajectory of the joint, the trajectories being generated using the map.

(9) The control apparatus according to (8), in which
when the manipulator moves retaining the target object by use of the holding unit and places the target object at a target reaching point in the operation region, the control unit determines the target reaching point on the basis of the map.

(10) The control apparatus according to (9), in which
the control unit determines the target reaching point in view of the placement stability information of the target object.

(11) The control apparatus according to any one of (1) to (10), in which
the control unit calculates a control parameter of the robot on the basis of the placement stability information of the object.

(12) The control apparatus according to any one of (1) to (11), in which
the control unit controls position and attitude of the robot on the basis of the placement stability information of the object.

(13) The control apparatus according to any one of (1) to (12), in which
the control unit calculates the placement stability of the object by use of a sensing result of a vision sensor that acquires surrounding information of the robot and a learning model.

(14) The control apparatus according to any one of (1) to (13), in which
the control unit generates the map by use of the placement stability information of the object, the placement stability information being obtained by another robot different from the robot.

(15) A control system, including:
a robot; and
a control unit controls an operation of the robot on the basis of a map of an operation region that reflects weighting of placement stability information of an object that forms the operation region of the robot, the map being generated by use of surrounding environment information of the robot.

(16) A control method, including:
generating a map of an operation region that reflects weighting of placement stability information of an object that forms an operation region of the robot by use of surrounding environment information of the robot; and
controlling an operation of the robot on the basis of the map.

(17) A robot, including
a control unit that controls an operation of the robot on the basis of a map of an operation region that reflects weighting of placement stability information of an object that forms an operation region of the robot, the map being generated using surrounding environment information of the robot.

### REFERENCE SIGNS LIST

1 control system
2 control apparatus
4, 104, 204, 304, 404, 504 control unit
5 robot
13 operation region
20 target object
21 object (object that forms space)
22a in-refrigerator floor (object that forms space)
22b in-refrigerator side surface (object that forms space)
22c in-refrigerator top surface (object that forms space)
26 trajectory
53 manipulator
54 joint
55 link
56 end effector (holding unit)
71 vision sensor
72 tactile sensor (first sensor)
73 force sensor (first sensor)

What is claimed is:

1. A control apparatus, comprising
a control unit that controls an operation of a robot on a basis of a map of an operation region that reflects weighting of placement stability information of an object that forms the operation region of the robot, the map being generated using surrounding environment information of the robot.

2. The control apparatus according to claim 1, wherein
the placement stability information of the object is calculated using one or more selected from a shape of the object, a contact area of the object with another object, a material of the object, a friction coefficient of the object, a contact state of the object with another object, rigidity of the object, result information when the robot operates on a basis of the map, and a deformation rate of the object during contact with the robot.

3. The control apparatus according to claim 1, wherein
the environment information is information based on a sensing result of a vision sensor that acquires surrounding information of the robot and the environment information includes shape information of the object, position information of the object in the operation region, and relative position relationship information between the robot and the object.

4. The control apparatus according to claim 1, wherein
the map is generated using the placement stability information of the object calculated in advance.

5. The control apparatus according to claim 1, wherein
the map is generated using the placement stability information of the object calculated using at least one of a sensing result of the first sensor provided in the robot and a sensing result of a vision sensor that acquires surrounding information of the robot.

6. The control apparatus according to claim 5, wherein
the placement stability of the object is calculated using at least one of a shape, a size, rigidity, a change in shape over time, and a contact area with another object of the object determined on a basis of at least one of the sensing result of the first sensor and the sensing result of the vision sensor.

7. The control apparatus according to claim 5, wherein
the first sensor includes at least one of a force sensor and a tactile sensor.

8. The control apparatus according to claim 1, wherein
the robot is provided with a manipulator having a joint, a link that rotates about the joint as a center, and a holding unit that holds or releases a target object, the manipulator being provided at a distal end, and
the control unit controls the operation of the robot on a basis of at least one of a trajectory of the holding unit and a trajectory of the joint, the trajectories being generated using the map.

9. The control apparatus according to claim 8, wherein
when the manipulator moves retaining the target object by use of the holding unit and places the target object at a target reaching point in the operation region, the control unit determines the target reaching point on a basis of the map.

10. The control apparatus according to claim 9, wherein
the control unit determines the target reaching point in view of the placement stability information of the target object.

11. The control apparatus according to claim 1, wherein
the control unit calculates a control parameter of the robot on a basis of the placement stability information of the object.

12. The control apparatus according to claim 1, wherein
the control unit controls position and attitude of the robot on a basis of the placement stability information of the object.

13. The control apparatus according to claim 1, wherein
the control unit calculates the placement stability of the object by use of a sensing result of a vision sensor that acquires surrounding information of the robot and a learning model.

14. The control apparatus according to claim 1, wherein
the control unit generates the map by use of the placement stability information of the object, the placement stability information being obtained by another robot different from the robot.

15. A control system, comprising:
a robot; and
a control unit controls an operation of the robot on a basis of a map of an operation region that reflects weighting of placement stability information of an object that forms the operation region of the robot, the map being generated by use of surrounding environment information of the robot.

16. A control method, comprising:
generating a map of an operation region that reflects weighting of placement stability information of an object that forms an operation region of the robot by use of surrounding environment information of the robot; and
controlling an operation of the robot on a basis of the map.

17. A robot, comprising
a control unit that controls an operation of the robot on a basis of a map of an operation region that reflects weighting of placement stability information of an object that forms an operation region of the robot, the map being generated using surrounding environment information of the robot.
